(19) United States
(12) Patent Application Publication
(10) Pub. No.: US 2008/0007940 A1
(43) Pub. Date: Jan. 10, 2008

(54) Luminescent zipper device

(75) Inventor: Ying-Lung Cheng, Taipei City (TW)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, omitted

(73) Assignee: Zipper Mart (Taiwan) Inc.

(21) Appl. No.: 11/480,939

(22) Filed: Jul. 6, 2006

(51) Int. Cl. F21V 21/08

(52) U.S. Cl. 362/103; 362/84

(57) ABSTRACT

A luminescent zipper device includes luminescent zipper strips which are provided with an EL material to be able to emit the luminescence by just receiving a weak electric current. This kind of luminescence source is provided with a high safety feature and a high visibility, and is able to effectively reduce a probability of accident. In addition, the luminescent zipper device has a simple structure and a cheap cost, and an accompanied driver can be designed according to different requirements of utilization, in order to generate different luminescence effects.

### BACKGROUND OF THE INVENTION

1. Field of the Invention

The present invention relates to a luminescent zipper device, and more particularly to a luminescent zipper device wherein its luminescent zipper strips are provided with an EL (Electro-Luminescent) material which can emit the luminescence just by receiving a weak electric current.

2. Description of the Prior Art

In nowadays, a zipper can be used for all kinds of purposes, including clothes, pants, purses, and shoes. These products are provided with a greater market potential and sales volume, and a higher value, through an extensive development. In addition, they bring a lot of convenience into an ordinary life. Recently, there are many designs of special purposes on the market, for example, a combination of reflective zipper with a reflective material enables the zipper to have different changes under different lights; these products which are provided with the reflection effect can match with a trend, and can be also used in the nighttime reflective clothes or purses. Furthermore, the zipper which have a reflection effect can emit lights of multiple colors by using the refraction properly, thereby effectively improving a value-added of original zippers. However, all of the aforementioned zipper products should depend upon a light source in an ambient environment and cannot emit or control the light by themselves.

Accordingly, how to eliminate the aforementioned problems is a technical issue to be solved by the present inventor.

### SUMMERY OF THE INVENTION

The primary object of present invention is to provide a luminescent zipper device which is provided with an EL (Electro-Luminescent) material to emit the luminescence through receiving a power source with a principle of transforming electricity into luminescence, thereby being convenient to use, and having a high safety feature.

Another object of the present invention is to provide a luminescent zipper device which is provided with a simple structure, is easy to be changed, and can even match with a proper driver to generate a different luminescence effect, thereby having a very broad application.

Accordingly, the luminescent zipper device disclosed by the present invention includes a pair of luminescent zipper strips, a plurality of zipper teeth, and a sliding tab, wherein an interior of the luminescent strip is provided with an EL material which can be pressed together with the luminescent zipper strip. The luminescent zipper device can emit the luminescence by connecting the EL material to a power source.

The plural zipper teeth are orderly locked at edges facing to the luminescent zipper, and the sliding tab is loosely installed on the zipper teeth. By pulling the sliding tab, the aforementioned zipper teeth are squeezed or loosened by the sliding tab to be mutually gnawed or separated.

Specifically, the luminescent zipper device of present invention can be even manufactured into an ordinary zipper, wherein a periphery of the luminescent zipper strip is provided with a side strip to facilitate a fixing, thereby being able to be applied to clothes, purses, or shoes. On the other hand, the luminescent zipper device can be directly formed into a loop type, such as a suspended decoration of a cellular phone or a baggage ring, which is provided with a function of zipper switch and can be even put around or suspended on a user or an object, along with a beauty and practicability.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a front view of the present invention.

FIG. 2 shows a side view of the present invention.

FIG. 3 shows an exploded view of the present invention.

FIG. 4 shows a perspective view of the present invention.

FIG. 5 shows a schematic view in using a luminescent zipper device of the present invention.

FIG. 6 shows a schematic view of a luminescent zipper device of the present invention which is provided with a side strip of luminescent zipper.

FIG. 7 shows a schematic view of a luminescent zipper device 90 of the present invention.

FIG. 8 shows a schematic view in using a luminescent zipper device 90 of the present invention.

FIG. 8A shows a partial enlarged view of a luminescent zipper device of the present invention including a sliding tab and a pull ring are provided with a luminescent effect.

FIG. 9 shows a schematic view of a luminescent zipper device of the present invention including a sliding tab that is provided with a luminescent effect.

FIG. 10 shows a schematic view of a luminescent zipper device of the present invention including a sliding tab and a pull ring that are provided with a luminescent effect.

### DETAILED DESCRIPTION OF THE PREFERRED EMBODIMENTS

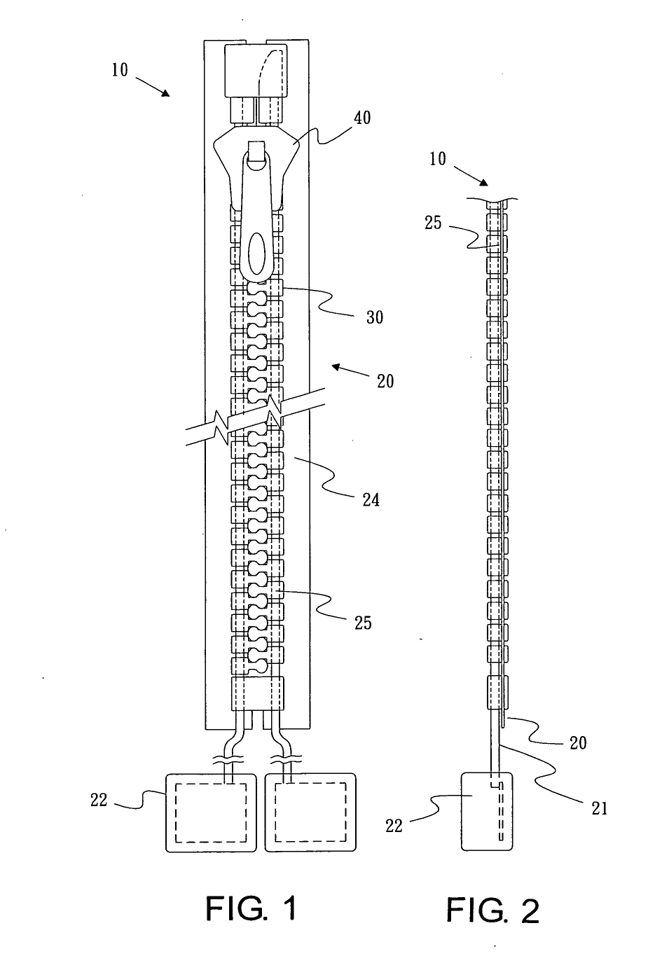

Referring to FIG. 1 and FIG. 2, a luminescent zipper device 10 of a first embodiment of present invention comprises primarily a pair of luminescent zipper strips 20, a plurality of zipper teeth 30, and a sliding tab 40. An interior of the luminescent zipper strip 20 includes an EL material 21 which can be a luminescent wire sold in a general market, wherein its center is usually a bendable copper wire, with its surface being coated with a special fluorescent material, next being wound around with two bare wires which are as thin as a hair, and then being enclosed by a plastic tube of different color, thereby constituting the luminescent wires of all kinds of different colors. The central copper wire is one polarity, the bare wires which are as thin as the air are the other polarity, and a luminescence can be emitted by energizing with an AC (Alternating Current).

For a luminescent source, an ordinary working voltage can be between 40 volts AC to 220 volts AC; whereas an ordinary working frequency can be between 50 Hertz to 4000 Hertz, after being adjusted. A brightness of luminescence will be increased by increasing the voltage, and the brightness can be also increased by increasing the frequency, yet with a change of color of luminescence at the same time. Therefore, an accompanied driver 22 will usually be designed according to a size of area of the EL material, the brightness of luminescence, an environment of utilization, and a lifetime, in order to drive the voltage and frequency of EL material 21, thereby providing a different luminescent effect.

The luminescent zipper strip 20 of the first embodiment is a type of plastic steel zipper, wherein the plastic steel is molded integrally with the aforementioned EL material 21. The pair of luminescent zipper strips 20 are parallel arranged, and a zipper assembly part 25 at an edge facing to the luminescent zipper strip 20 is provided with a plurality of plastic steel zipper teeth 30; whereas the sliding tab 40 is loosely installed on the plastic steel zipper teeth 30 to control an opening and closing of the luminescent zipper strips 20. On the other hand, the luminescent zipper strip 20 of the embodiment is an open zipper, wherein an extreme end of the plastic steel teeth 30 at one side of the luminescent zipper strip 20 is provided with a stopping block 26 which can prevent the sliding tab 40 from passing through. In addition, to facilitate a utilization of the luminescent zipper strip 20, two drivers 22 can be designed to drive the luminescent zipper strips 20 separately. In a practical application, the luminescent zipper strip 20 of the embodiment can be also a close zipper.

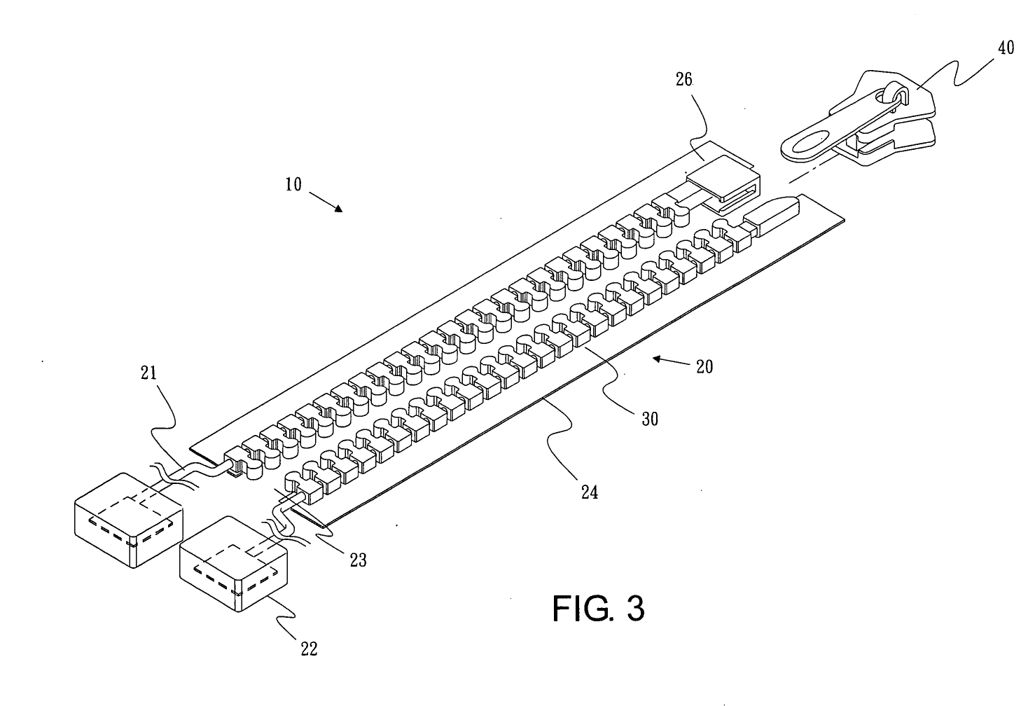

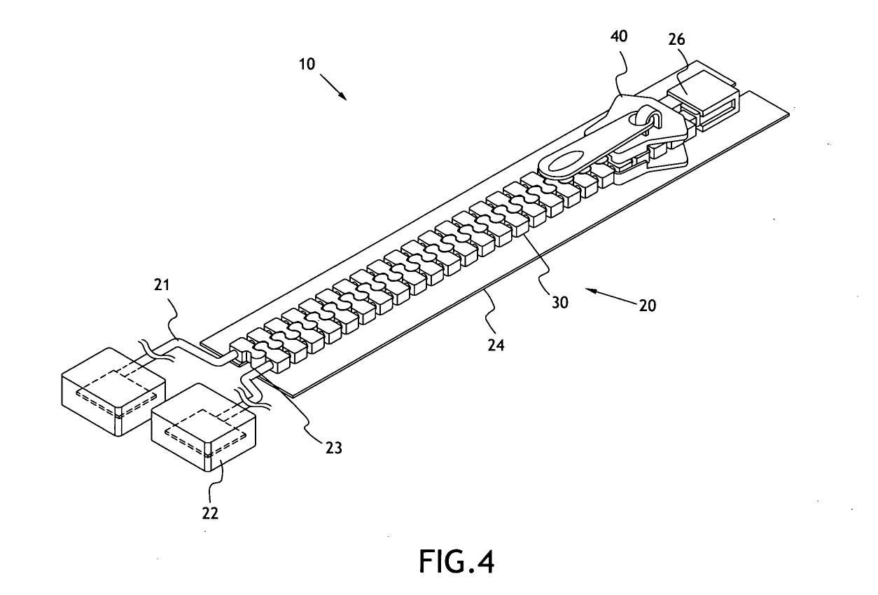

Referring to FIG. 3 and FIG. 4, the plastic steel zipper teeth are in a sawtooth shape, can be orderly arranged, and can be mutually gnawed. The sliding tab 40 can be fed in from an import end 23 of the luminescent zipper strip 20, and the plastic steel zipper teeth 30 can be squeezed by the sliding tab 40 such that they are closed to each other and mutually gnawed to gradually close the luminescent zipper strips 20 (as shown in FIG. 2), by using a force of pulling the sliding tab 40.

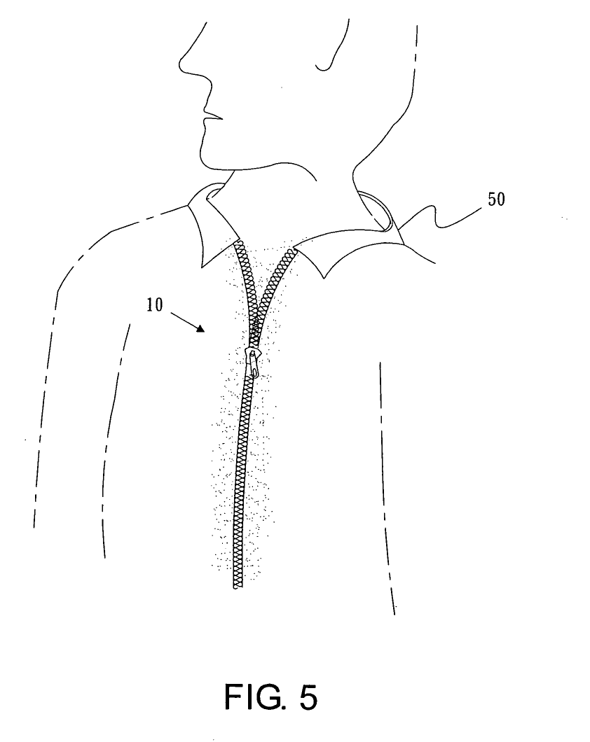

The luminescent zipper strip 20 can be made by a water-proof plastic material, such as the Polyvinyl Chloride (PVC) or the Polyurethane (PU). Moreover, a periphery of the luminescent zipper strip 20 can be extended outward to form a side strip 24, so as to be easily fixed on other object. Referring to FIG. 5, the luminescent zipper strips 20 can be fixed on a clothe 50, a purse, or shoes, to serve as an ordinary zipper switch. It is naturally that the present invention is not limited to this kind of application.

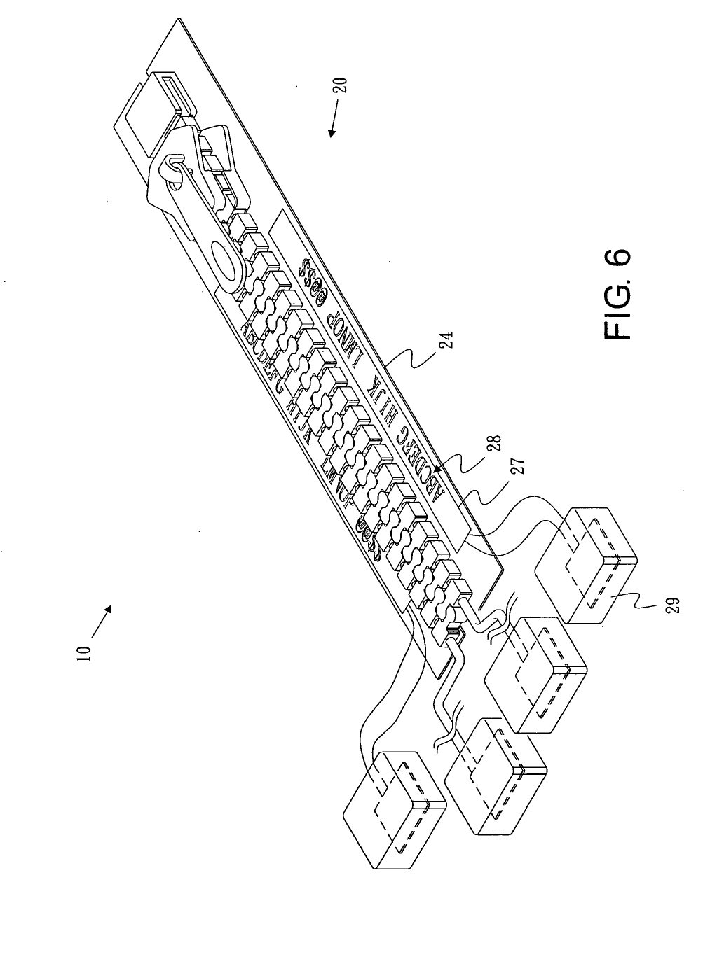

Referring to FIG. 6, the side strip 24 of luminescent zipper strip 20 can also be provided with an EL material 27 which is constituted by a luminescent strip and can be formed with a plurality of patterns 28 to provide a purpose of identification or decorating. In addition, the EL material 27 emits the luminescence through a driving of a driver 29.

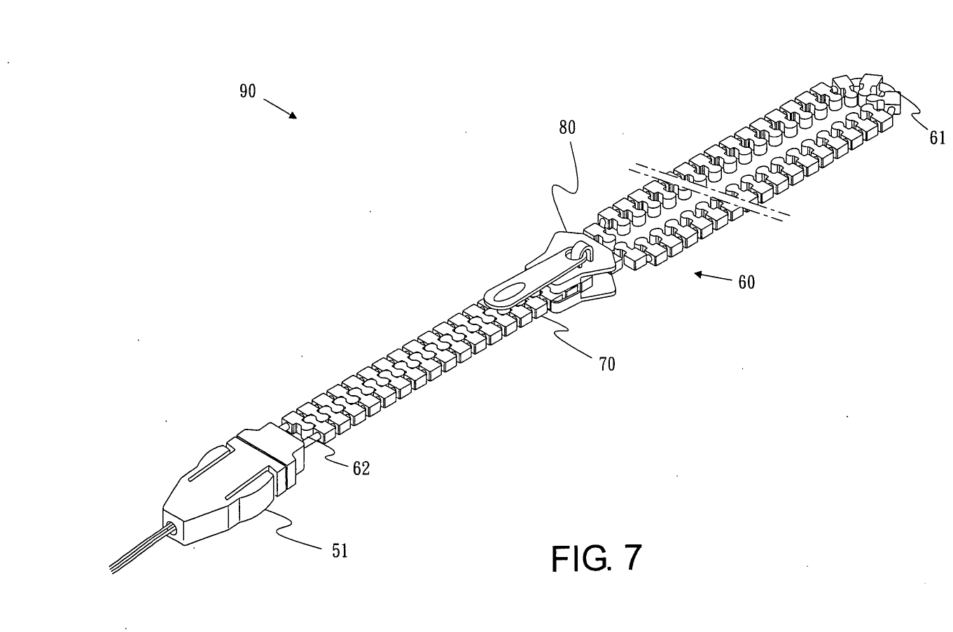

Referring to FIG. 7, it shows a schematic view of a luminescent zipper device 90 provided by a second embodiment of present invention. A luminescent zipper strip 60 of this embodiment is different than that of the first embodiment in that a close end 61 and an import end 62 are formed, zipper teeth 70 can be fed in from the import end 62 to be mutually gnawed with a sliding tab 80, and a periphery of the luminescent zipper strip 60 is not provided with an extended side strip. In a practical application, the luminescent zipper strip 60 can be a luminescent wire which is directly molded by pressing and is bended into two sections.

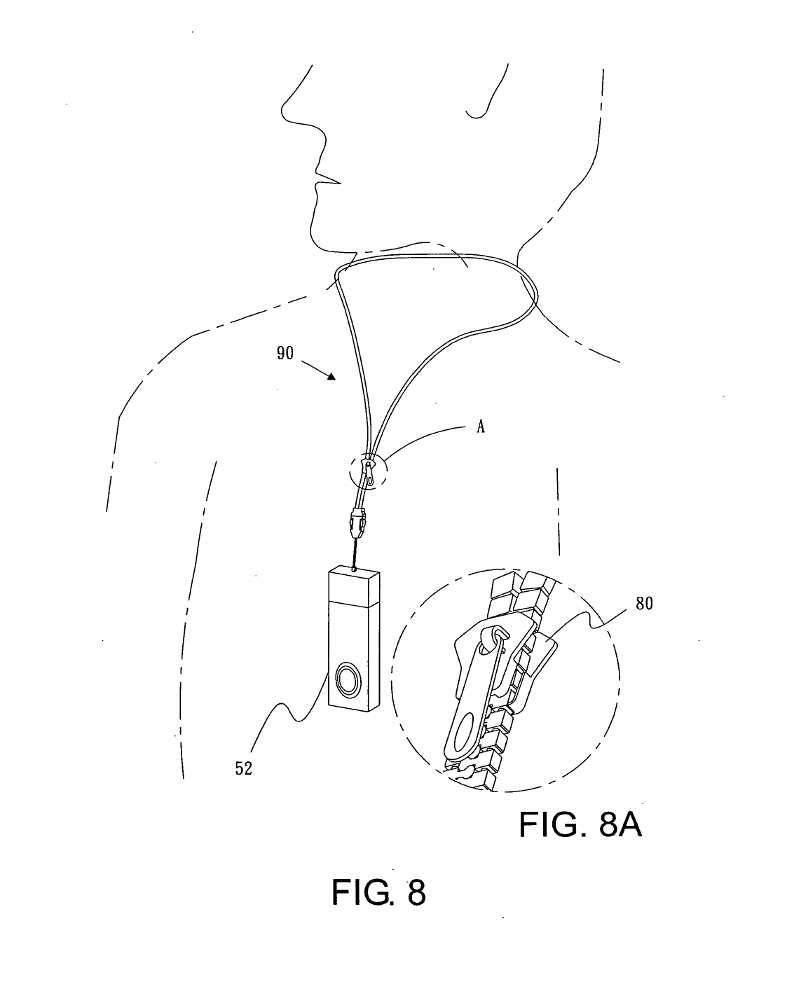

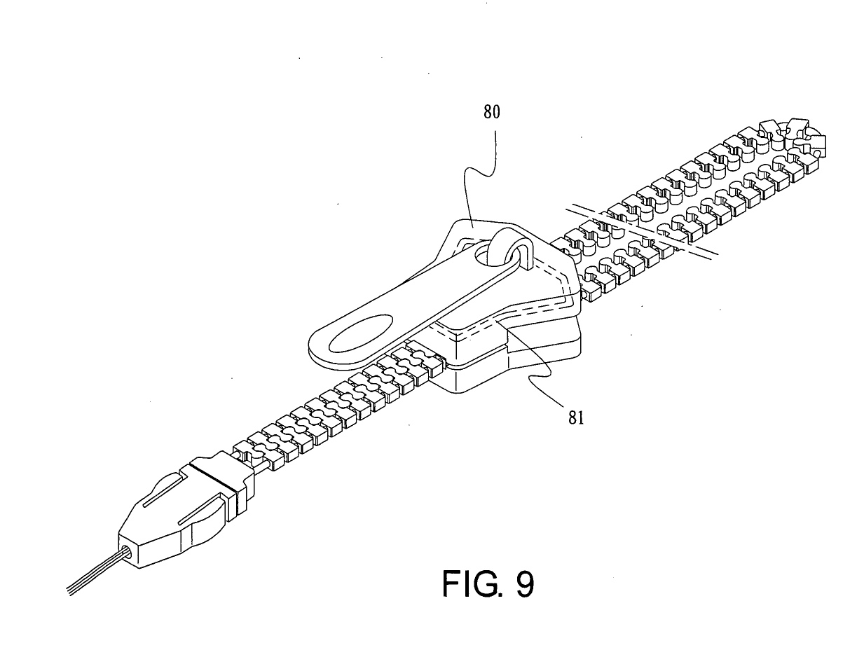

The import end 62 of luminescent zipper strip 60 can be combined with other element, such as fixing member 51, to form a suspended decoration. Referring to FIG. 8 and FIG. 8A, due to its function of zipper switch, the luminescent zipper device 90 can be made into a suspended decoration of a cellular phone 52, and can be put around on a human body. It is naturally that the luminescent zipper device 90 can be also applied to a product such as a baggage ring, a cellular phone, a camera, or an MP3 player, which is able to achieve a practicability and safety, and can also serve as a luminescent decoration. Moreover, an interior of the sliding tab 80 of this embodiment can be emplaced with an EL material 81 which can receive a power source to emit a luminescence, thereby bringing more versatile visual effects. The sliding tab 80 can be also emplaced with a driver to provide the power source, which will not be described further.

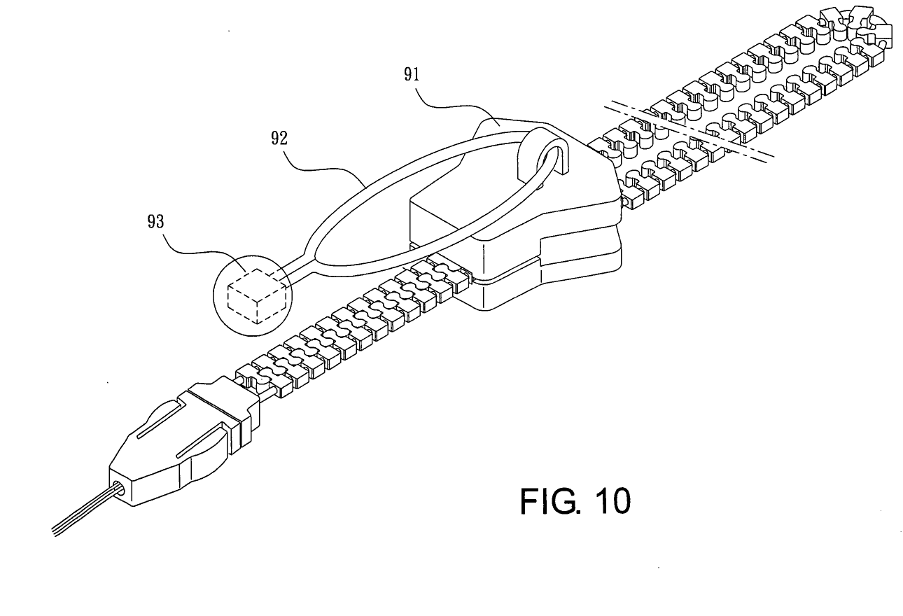

Referring to FIG. 10, a pull ring at a front end of sliding tab 91 is also made by an EL material 92 which can be formed by directly bending a luminescent wire. On the other hand, an end of the sliding tab 91 can be also provided with a driver 93 to use cooperatively, which will not be described further.

Accordingly, the luminescent zipper device provided by the present invention utilizes a principle of transforming electricity into luminescence to design the luminescent zipper strip which contains the EL material, such that the luminescence can be emitted only with a weak electric current. In addition, the luminescent source itself is provided with a high safety feature, is provided with an extremely high visibility, and is able to reduce a probability of accident.

On the other hand, the luminescent zipper device of present invention is provided with a simple structure and a cheap cost, and the accompanied driver can be designed according to different requirements of utilization, such that a strength, a gray level, a frequency or a change of color, of the luminescent source can be controlled, thereby achieving different visual effects, and enabling a customer product to be more versatile.

To further manifest the advancement and practicability of the present invention, the present invention is compared with a conventional zipper device as follows:

Shortcomings of a Conventional Zipper Device
1. it cannot emit the luminescent by itself and should depend upon a light source in an ambient environment.
2. it cannot control the luminescence and should depend upon a light source in an ambient environment.

### ADVANTAGES OF THE PRESENT INVENTION

1. The EL material can be designed into the luminescent zipper strip, using a principle of transforming electricity into luminescence.
2. According to item 1, it is convenient to use and is provided with a high safety feature, through receiving a power source to emit the luminescence.
3. It can be used in cooperation with a proper driver to generate different luminescence effects.
4. It is provided with advancement and practicability.
5. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A luminescent zipper device comprising a pair of luminescent zipper strips, which is provided with an EL (Electro-Luminescent) material to receive a power source for emitting the luminescence; a plurality of zipper teeth which are locked at an edge facing to the luminescent zipper strip; and a sliding tab which can be loosely installed on the zipper teeth which can be mutually gnawed or separated, by a pulling of the sliding tab; including further a driver which is connected with the EL material for providing a required power source to the EL material to emit the luminescence.

2. (canceled)

3. The luminescent zipper device according to claim 1, wherein the pair of luminescent zipper strips are a type of plastic steel zipper.

4. The luminescent zipper device according to claim 1, wherein the EL material is molded integrally with the luminescent zipper strip by pressing.

5. The luminescent zipper device according to claim 1, wherein the luminescent zipper strip is directly molded with a luminescent wire by pressing.

6. The luminescent zipper device according to claim 1, wherein ends of the pair of luminescent zipper strips are assembled together.

7. The luminescent zipper device according to claim 1, wherein the pair of luminescent zipper strips are formed by folding a same luminescent wire.

8. The luminescent zipper device according to claim 1, wherein outer sides of the pair of luminescent zipper strips are extended to form side strips for fixing.

9. The luminescent zipper device according to claim 8, wherein the side strip includes an EL material which can receive a power source to emit the luminescence.

10. The luminescent zipper device according to claim 9, wherein the side strip further includes a driver connected to the EL material of side strip, so as to provide a required power source to the EL material for emitting the luminescence.

11. The luminescent zipper device according to claim 9, wherein the EL material is formed into a plurality of patterns.

12. The luminescent zipper device according to claim 9, wherein the luminescent zipper strip is made by a water-proof plastic material.

13. The luminescent zipper device according to claim 1, wherein an interior of the sliding tab includes an EL material which can receive a power source to emit the luminescence.
